(19) United States
(12) Patent Application Publication
(10) Pub. No.: US 2011/0196616 A1
(43) Pub. Date: Aug. 11, 2011

(54) APPARATUS FOR AND METHOD OF MEASURING PERCEIVED AGE

(75) Inventor: David Andrew Gunn, Sharnbrook (GB)

(73) Assignee: CONOPCO, INC., D/B/A UNILEVER, Englewood Cliffs, NJ (US)

(21) Appl. No.: 12/957,436

(22) Filed: Dec. 1, 2010

(30) Foreign Application Priority Data
Dec. 2, 2009 (EP) EP09177781

(51) Int. Cl. G01N 21/55; G06F 19/00

(52) U.S. Cl. 702/19; 356/448

(57) ABSTRACT

This invention relates to an apparatus for and a method of measuring skin glow and/or skin radiance and/or skin shine and/or the biological age of the skin of an individual.

As an individual ages, their appearance changes due to structural alterations to their tissues. These visible signs of aging, such as loss of skin glow or radiance, mean that other individuals are an indication of the age of an individual. In a population of individuals, some will appear younger and some will appear older than their chronological age. In these cases the aforementioned visible signs of aging are an indication of how well the skin of the individual is aging, in other words an indication of the biological age of the skin of the individual. Trained human age assessors are able to reproducibly determine the biological age of the skin of the individual. However automation would facilitate its use in almost any research or consumer setting. Thus a method of determining skin glow and/or skin radiance and/or skin shine and/or the biological age of the skin of an individual is provided, the method comprising the steps of:
(a) Determining the number or sum of areas of at least one predetermined facial skin region of a test individual, the areas having:
   (i) a predetermined minimum specular reflectance and having predetermined maximum area; or
   (ii) a predetermined minimum specular reflectance and having a predetermined minimum area; or
   (iii) a predetermined maximum specular reflectance and having a predetermined maximum area; or
   (iv) a predetermined maximum specular reflectance and having a predetermined minimum area;
(b) Determining the biological age of the skin of the test individual from a previously obtained graph or equation relating chronological age of an individual to the number or sum of areas of the at least one predetermined facial skin region of an individual, the areas being defined according to step (a).

This invention relates to an apparatus for and a method of measuring skin glow and/or skin radiance and/or skin shine and/or the biological age of the skin of an individual.

The micro-texture of the skin influences how light reflects off it because surface curvatures change the angle of incidence of light. Such changes in the angle of incidence determine whether the light reflected to a particular observational position is specular light or diffuse light, ie it has first interacted with the skin before being reflected. Light from specular reflection is, when using a light source of visible light, brighter and whiter and more representative of the source of light than light that interacted with the skin. Thus measurement of the areas of specular light reflected from the skin is representative of the micro-texture of that skin.

As an individual ages, their appearance changes due to structural alterations to their tissues. These visible signs of aging, such as flattening of skin micro-structure and loss of skin glow, radiance and shine, are an indication of the age of an individual. In a population of individuals, some will appear younger and some will appear older than their chronological age. In these cases the aforementioned visible signs of aging are an indication of how well the skin of an individual is aging, in other words an indication of the biological age of the skin of an individual.

WO 01/53805 A1 discloses a system for the non-invasive estimation of relative age based on the irradiation of skin tissue with near-infrared light.

WO2008/028893 A1 discloses a method of measuring blemishes on skin comprising the steps of:
(a) acquiring a colour digital image of the skin;
(b) selecting either the blue or the green colour channel of the image based on the average colour of the skin;
(c) subjecting the selected colour channel to a Gaussian filter operation to obtain an intensity value for each pixel;
(d) binarizing the image into pixels of either a black or a white colour using a predetermined threshold intensity value; and
(e) counting the number of black pixels.

This invention relates to an automated method and apparatus for measuring specular reflectance from the surface of facial skin from a source of visible light to determine the biological age of the skin of an individual.

### SUMMARY OF THE INVENTION

In a first aspect of the invention, a method of determining skin glow and/or skin radiance and/or skin shine and/or the biological age of the skin of an individual is provided, the method comprising the steps of:
(a) Determining the number or sum of areas of at least one predetermined facial skin region of a test individual, the areas having:
   (i) a predetermined minimum specular reflectance and having a predetermined maximum area; or
   (ii) a predetermined minimum specular reflectance and having a predetermined minimum area; or
   (iii) a predetermined maximum specular reflectance and having a predetermined maximum area; or
   (iv) a predetermined maximum specular reflectance and having a predetermined minimum area;
(b) Determining the biological age of the skin of the test individual from a previously obtained graph or equation relating chronological age of an individual to the number or sum of areas of the at least one predetermined facial skin region of an individual, the areas being defined according to step (a).

The term “skin glow” is a measure of a bright and luminous flushed and rosy colour.

The term “skin radiance” is a measure of a bright and luminous even complexion with a fine grain.

The term “skin shine” is a measure of a bright and luminous reflective appearance.

By the term “specular reflectance” is meant mirror-like reflection of light from a surface in which light from a single incoming source is reflected into a single outgoing direction. The light may be of any wavelength able to undergo specular reflectance from the surface of facial skin, preferably it is visible light.

Without being bound by theory, it is thought that, when young, an individual has finely textured skin comprising many small (50-500 microns in diameter) convex areas which are able to reflect visible light in a specular manner. As the individual ages, their skin gradually loses the fine texture of youth as obvious signs of aging such as wrinkles start to appear. As a consequence of this, the degree of specular reflectance from the small (50-500 microns in diameter) convex areas of the surface of the skin of older individuals reduces and hence the degree of skin glow, radiance and shine decreases with a concomitant increase in apparent age. The inventive method capitalises on this observation by measuring this decrease in specular reflectance with skin aging according to a minimum threshold specular reflectance and maximum threshold size of area. The number or sum of the measured areas is then associated with the biological age of the skin of an individual by comparing the aforementioned sum to a previously obtained graph or equation relating number or sum of areas to chronological age.

In view of this, it can be seen that other numbers or sums of areas can be measured which also correlate with the biological age of the skin of an individual as set forth in the first aspect by combining in various ways the thresholds for the specular reflectance and size of the areas.

The previously obtained graph or equation may be obtained by:
(a) Determining the number or sum of areas of the at least one predetermined facial skin region of each of a plurality of individuals of known chronological age, the areas being defined according to step (a) of the first aspect thereby to obtain a dataset;
(b) Performing regression on the dataset to obtain a relationship between the chronological age of an individual and the number or sum of areas of the at least one predetermined facial skin region for that individual, the areas being defined according to step (a) of the first aspect.

The areas must be firstly filtered according to specular reflectance and secondly filtered according to area.

As skin aging may vary with racial heritage, preferably the plurality of individuals and the test individual have the same racial heritage, for example European or Asian. Furthermore as skin aging may vary with gender as well, preferably the plurality of individuals and the test individual are selected only of women or only of men.

The at least one predetermined facial region may be selected from the group consisting of a crow's feet region, a cheek region, a lower cheek beside a mouth region, an upper lip region, a jaw region, a forehead region and a combination thereof. The aforementioned predetermined facial regions are particularly associated with the visible signs of aging.

The predetermined maximum area preferably has a longest dimension of no greater than 200, more preferably no greater than 500, most preferably no greater than 2000 microns and the predetermined minimum area preferably has a longest dimension of greater than 200, more preferably greater than 500, most preferably greater than 2000 microns.

The aforementioned regression may be selected from the group consisting of linear, polynomial, exponential and logarithmic. Preferably the regression is linear.

In one preferred embodiment of the first aspect, the number or sum of areas of at least one predetermined facial skin region of a test individual is determined from one or more digital photographs, the areas being defined according to step (a) of the first aspect. In this case, the minimum specular reflectance may be measured as a minimum pixel lightness value and the maximum specular reflectance may be measured as a maximum pixel lightness value. Preferably the minimum pixel lightness value is greater than the mean pixel lightness, more preferably greater than one standard deviation above the mean pixel lightness and the maximum pixel lightness value is preferably no more than the mean pixel lightness, more preferably no more than one standard deviation above the mean pixel lightness.

By the term “mean pixel lightness” is meant the mean of all the pixel lightness values of the pixels in the predetermined facial skin region taken from one digital photograph.

Furthermore the pixel lightness value may be represented by one of the measurements selected from the group consisting of the Value measurement in HSV colour space (Hue, Saturation, Value); the intensity of any one of the red, green or blue colours of the RGB (Red, Green, Blue) colour space; the L value in the CieLab colour space; the intensity of any one of the cyan, magenta or yellow colours of the CMYK colour space; the lightness measure in HSL colour space (Hue, Saturation, Lightness); and the Y′ measurement (luma component) of the Y′UV colour space. The pixel lightness value represented by the Value measurement in HSV colour space (Hue, Saturation, Value) is preferred because it is a good measure of specular reflectance.

The aforementioned embodiment of the first aspect may additionally comprise any one of the following steps:
(a) Saving one or more digital photographs in RGB (Red, Green, Blue) colour space thereby to produce one or more RGB digital photographs;
(b) Applying a flat field correction to the saved one or more RGB digital photographs thereby to produce one or more flat fielded RGB digital photographs;
(c) Converting one or more flat fielded RGB digital photographs to any one of the aforementioned colour spaces thereby to produce one or more digital photographs in any one of the colour spaces; and
(d) Normalising the number or sum of areas of at least one predetermined facial skin region of a test individual to the size of the predetermined facial skin region.

The advantage of flat field correction is that it corrects the RGB digital photographs to account for any large areas of shading present as a result of large scale curvature present in the images from, for example, the cheek region, which may be present and which may distort the degree of specular reflectance. The correction is done by, in effect, flattening any large scale curvature present in the images through dividing each pixel lightness value with a low pass filtered lightness value for that pixel.

The advantage of the aforementioned normalisation step is so that the number or sum of areas is not only determined for the same predetermined facial skin region, for example, the cheek region, but also is determined for a predetermined size of that predetermined facial skin region (the same size as used to obtain the graph or equation set forth in the first aspect of the invention hereinabove so that the biological age of the skin of the test individual can be obtained therefrom).

In a second aspect of the invention, a method for determining the improvement in skin appearance of a test individual is provided, the method comprising:
(a) determining skin glow and/or skin radiance and/or skin shine and/or the biological age of the skin of a test individual in accordance with the first aspect of the invention; then
(b) treating the skin with an oral or topical skin care composition; and then
(c) determining skin glow and/or skin radiance and/or skin shine and/or the biological age of the skin of a test individual in accordance with the first aspect of the invention after treatment step (b)

Alternatively, the second aspect of the invention can also measure the effectiveness of an oral or topical anti-aging composition.

In a third aspect of the invention, a computer program product is provided, the computer program product being directly loadable into the internal memory of a digital computer comprising software code portions for performing the steps of the first aspect of the invention when the product is run on the computer.

In a fourth aspect of the invention, a computer usable storage device is provided, the computer usable storage device comprising the computer program product of the third aspect stored thereon.

In a fifth aspect of the invention, an apparatus for determining skin glow and/or skin radiance and/or skin shine and/or the biological age of the skin of a test individual is provided, the apparatus comprising:
(a) A digital camera; and a
(b) A digital computer operably linked to the camera such that data gathered by the camera can be downloaded to the computer, the computer comprising the computer program product of the third aspect of the invention stored on an internal memory thereof.

### BRIEF DESCRIPTION OF THE FIGURES

The invention will now be illustrated with reference to the following figures in which:

FIG. 1 shows the six regions of crow's feet, the cheek, the lower cheek beside the mouth, the upper lip, the jaw and the forehead on a 45 degree photographic image which are extracted as separate images in RGB colour space;

FIGS. 2a and 2b show, for the crow's feet region, the extracted image immediately after extraction (FIG. 2a) and after the dual screening process for the V value and for area size (FIG. 2b); and

FIG. 3 shows a scatter plot of the number of skin shine areas in the crow's feet region of the left eye in 206 Spanish females divided by the total number of pixels in the aforementioned region, ie normalised number of areas, versus chronological age.

### DETAILED DESCRIPTION OF THE INVENTION

### Subjects

230 Caucasian females aged between 30 and 70 years and resident in the Madrid area of Spain In addition and 239 Chinese females aged between 25 and 70 years from the Shanghai area of China were selected according to the following inclusion and exclusion criteria:

### Inclusion Criteria:

1) In good general health.
2) Free of cuts, lacerations, abrasions, bruises, and excessive hair or blemishes on the test site.

### Exclusion Criteria:

1) Pregnant or breast feeding.
2) Presence of existing skin conditions on the face or neck, such as psoriasis, eczema,
   Hyper-/hypopigmentation or a history of any type of skin cancer.
3) Botox users.
4) Have had any surgery on the face or neck.
5) Have had any laser treatment on the face or neck.
6) Have participated in a study where the face or neck was the target area within four weeks of the start of the photographic session.

Each subject was given specific instructions to follow prior to their photographic session:
Do not use make-up on the day of the photographic session prior to the photographic session.
Do not use any skin products (creams, lotions, moisturizers, foundations) on or near the face or neck on the day of the photographic session prior to the photographic session.
Do not use any self-tanning lotion on your face and neck within one week of the photographic session.
Do not consume any hot or caffeinated beverages for one hour prior to the photographic session.
Do not consume any alcohol for 24 hours prior to the photographic session.
Do not engage in extreme physical exertion for at least one hour prior to the photographic session.

On the day of the photographic session, each subject was asked to use a facial wipe to remove perspiration.

### Photography

Photographs were taken of each subject from the left side of each subject's face (45 degree photographic images) using for the Spanish cohort a computer controlled Fuji S2 Pro Digital SLR Body fitted with a Nikkor 60 mm F2.8 AF-D micro lens digital camera connected to two Nikon SB80DX flash guns placed behind the camera and for the Chinese cohort a computer controlled Fuji S3 Pro Digital SLR body fitted with a Nikkor 60 mm F2.8 AF-D micro lens connected to two Sunpak MDF500 Digitflash 500 light panels.

The camera was set up in a 2 m×3 m room with the facility to exclude natural light and to adjust ambient lighting. Before photography and at regular intervals, a white light balance was performed using a grey card. Each subject's hair was pinned back to expose the hair line. Residual makeup and jewelry were removed. A cloth was then arranged to cover the shoulders and front to hide any clothing. Any high neck clothing (eg polo necks) was lowered to ensure that the middle and upper parts of the neck were visible. The room lights were then dimmed and focussing achieved using the focussing light. A Macbeth colour checker chart was positioned against the cloth below the subject's neck area ensuring that the red, green and blue squares were in shot. The subject was then asked to close their eyes and mouth and the photograph was taken. The 45 degree photographic image requires the nose should hide all but the outer-side of the eyelid and eyelashes of the right eye to the camera.

Extracting Images of the Predetermined Facial Skin Regions from the Photographs

A software program was created to extract images of the crow's feet region, the cheek region, the lower cheek beside the mouth region, the upper lip region, the jaw region and the forehead region from the 45 degree photographic images. FIG. 1 illustrates the six aforementioned regions on a 45 degree photographic image. The extracted images were stored as Tiff format files in RGB (Red Green Blue) colour space.

### Determining the Number or Sum of Areas of at Least One Predetermined Facial Skin Region

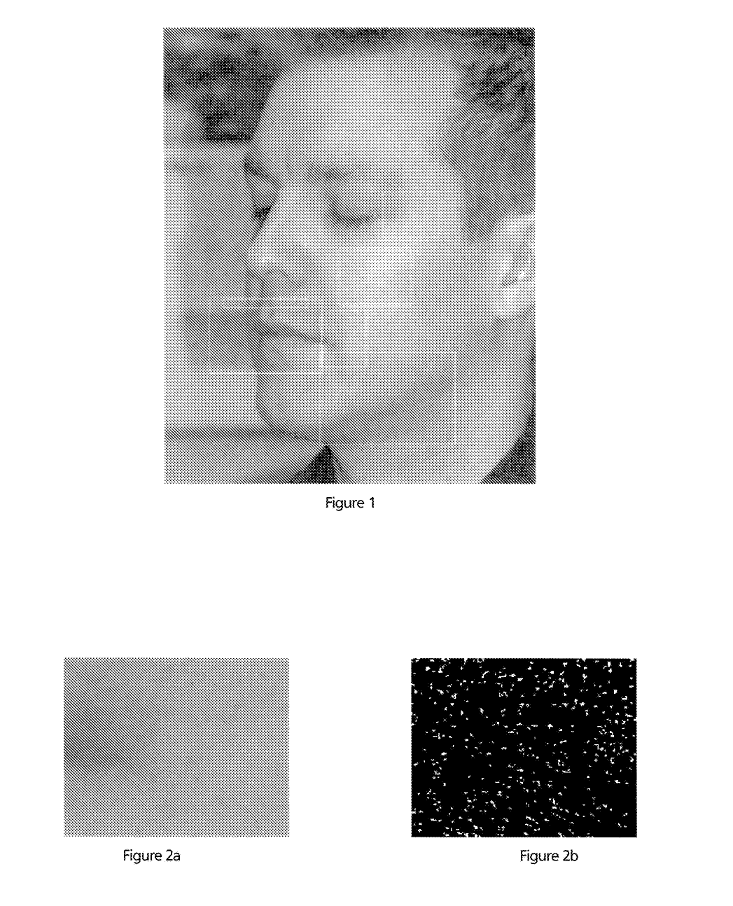

The extracted images were then processed initially involving flat field correcting each extracted image and then converting the resultant image to HSV colour space. The mean and standard deviation values of V were calculated, and those pixels with a V value below one standard deviation higher than the mean value were excluded. This first screening process rejected darker less bright and less white pixels and left pixels that were the brightest and whitest. Subsequently the pixels that remained were screened to leave groups of pixels (areas) of largest dimension of no greater than 500 microns by rejecting groups consisting of two pixels (of largest dimension of no greater than about 50 microns) and single pixels not touching any other pixels. This latter second screening process left small (of largest dimension of no greater than 500 microns) areas comprising the brightest and whitest pixels. FIG. 2 illustrates, for the crow's feet region, the extracted image before and after the aforementioned dual screening process for the V value and for area size. The white speckles represent the small areas comprising the lightest and shiniest pixels which are due to the specular reflection from the skin representative of the micro-texture of that skin.

The number and the sum of small areas were determined and then normalised to a predetermined size of the predetermined facial skin region.

### Results

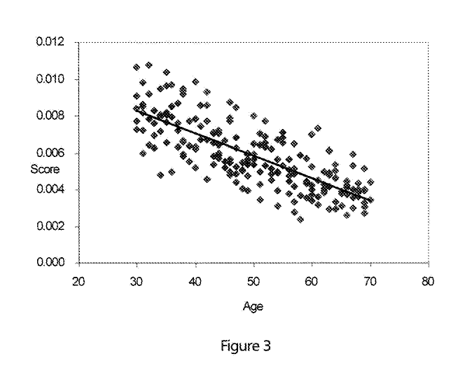

The normalised values were then divided by the total number of pixels in the predetermined facial skin region and illustrated as a scatter plot versus the chronological age as illustrated in FIG. 3 which presents the results for the number of small areas per pixel in the crow's feet region of the left eye for 206 of the Caucasian Spanish females versus their chronological age from which it is apparent that there is a significant decrease in the number of small areas per pixel detected with increasing age. A Pearson correlation value was calculated from the plot and is tabulated hereinbelow in table 1 with those for four (excluding the forehead) of the other predetermined facial region. Pearson correlation values range from −1 to +1 with a correlation of zero indicating no linear correlation. The value is +1 for an increasing linear relationship and −1 for a decreasing linear relationship, with values closer to +1 and −1 indicating a stronger correlation. In view of this, strong correlations between the numbers of small areas detected with increasing age were found for each predetermined facial region tested.

TABLE 1
Pearson correlation values for the relationship between the numbers of
small areas divided by the total number of pixels in the predetermined
facial skin region from various predetermined facial regions and the
chronological ages of 206 Spanish women.

| Predetermined facial region | Pearson correlation values |
|---|---|
| Crow's feet | −0.77 |
| Cheek | −0.60 |
| Lower cheek beside mouth | −0.64 |
| Upper lip | −0.66 |
| Jaw | −0.70 |

Table 2 hereinbelow presents similar results obtained from the Chinese cohort. Once again strong correlations between the numbers of small areas detected with increasing age were found for each predetermined facial region tested.

TABLE 2
Pearson correlation values for the relationship between the numbers of
small areas divided by the total number of pixels in the predetermined
facial skin region from various predetermined facial regions and the
chronological ages of 239 Chinese women.

| Predetermined facial region | Pearson correlation values |
|---|---|
| Crow's feet | −0.65 |
| Cheek | −0.46 |
| Lower cheek beside mouth | −0.48 |
| Upper lip | −0.17 |
| Jaw | −0.53 |

It should be noted that the aforementioned dual screening process was optimised by varying the V value and for area size thresholds to give the best Pearson correlation value for the Crow's feet region of the left eye for the Spanish cohort. No further optimisation was carried out for other predetermined facial regions or for the Chinese cohort and this may explain the generally slightly weaker Pearson correlation values obtained for the Chinese cohort and in particular for the upper lip region.

### Method for Determining the Improvement in Skin Appearance of a Test Individual

The improvement in skin appearance of a test individual can be determined by firstly determining the biological age of the skin of the test individual in accordance with the first aspect of the invention, then treating the skin with, for example, L'Oreal Derma Genesis™ Night Cream as directed for six months, and then determining the biological age of the skin again in accordance with the first aspect of the invention to have been reduced.

1. A method of determining skin glow and/or skin radiance and/or skin shine and/or the biological age of the skin of an individual, the method comprising the steps of:
(a) Determining the number or sum of areas of at least one predetermined facial skin region of a test individual, the areas having:
(i) a predetermined minimum specular reflectance and having a predetermined maximum area; or
(ii) a predetermined minimum specular reflectance and having a predetermined minimum area; or
(iii) a predetermined maximum specular reflectance and having a predetermined maximum area; or
(iv) a predetermined maximum specular reflectance and having a predetermined minimum area;
(b) Determining the biological age of the skin of an individual from a previously obtained graph or equation relating chronological age of an individual to the number or sum of areas of the at least one predetermined facial skin region of an individual, the areas being defined according to step (a).

2. A method according to claim 1 wherein the previously obtained graph or equation is obtained by:
(a) Determining the number or sum of areas of the at least one predetermined facial skin region of each of a plurality of individuals of known chronological age, the areas being defined according to step (a) of claim 1 thereby to obtain a dataset;
(b) Performing regression on the dataset to obtain a relationship between the chronological age of an individual and the number or sum of areas of the at least one predetermined facial skin region for that individual, the areas being defined according to step (a) of claim 1.

3. A method according to claim 2 wherein the plurality of individuals and the test individual have the same racial heritage.

4. A method according to claim 2 wherein the plurality of individuals and the test individual are selected only of women or only of men.

5. A method according to claim 1 wherein the at least one predetermined facial region is selected from the group consisting of a crow's feet region, a cheek region, a lower cheek beside a mouth region, an upper lip region, a jaw region, a forehead region and a combination thereof.

6. A method according to claim 1 wherein the predetermined maximum area has a longest dimension of no greater than 200, preferably no greater than 500, more preferably no greater than 2000 microns and the predetermined minimum area has a longest dimension of greater than 200, preferably greater than 500, more preferably greater than 2000 microns.

7. A method according to claim 1 wherein the regression is selected from the group consisting of linear, polynomial, exponential and logarithmic.

8. A method according to claim 1 wherein the number or sum of areas of at least one predetermined facial skin region of a test individual is determined from one or more digital photographs, the areas being defined according to step (a) of claim 1.

9. A method according to claim 8 wherein the minimum specular reflectance is measured as a minimum pixel lightness value and the maximum specular reflectance is measured as a maximum pixel lightness value.

10. A method according to claim 9 wherein the minimum pixel lightness value is greater than the mean pixel lightness, preferably greater than one standard deviation above the mean pixel lightness and the maximum pixel lightness value is no more than the mean pixel lightness, preferably no more than one standard deviation above the mean pixel lightness.

11. A method according to claim 9 wherein the pixel lightness is represented by one of the measurements selected from the group consisting of the Value measurement in HSV colour space (Hue, Saturation, Value); the intensity of any one of the red, green or blue colours of the RGB (Red, Green, Blue) colour space; the L value in the CieLab colour space; the intensity of any one of the cyan, magenta or yellow colours of the CMYK colour space; the lightness measure in HSL colour space (Hue, Saturation, Lightness); and the Y′ measurement (luma component) of the Y′UV colour space.

12. A method according to claim 1 comprising any one of the following steps:
(a) Saving one or more digital photographs in RGB (Red, Green, Blue) colour space thereby to produce one or more RGB digital photographs;
(b) Applying a flat field correction to the saved one or more RGB digital photographs thereby to produce one or more flat fielded RGB digital photographs;
(c) Converting one or more flat fielded RGB digital photographs to any one of the colour spaces of claim 11 thereby to produce one or more digital photographs in any one of the colour spaces of claim 11; and
(d) Normalising the number or sum of areas of at least one predetermined facial skin region of a test individual to the size of the predetermined facial skin region.

13. A method for determining the improvement in skin appearance of a test individual, the method comprising:
(a) determining skin glow and/or skin radiance and/or skin shine and/or the biological age of the skin of a test individual in accordance with any one of the preceding claims; then
(b) treating the skin with an oral or topical skin care composition; and then
(c) determining skin glow and/or skin radiance and/or skin shine and/or the biological age of the skin of a test individual in accordance with any one of the preceding claims after treatment step (b).

14. A computer program product directly loadable into the internal memory of a digital computer comprising software code portions for performing the steps of claim 1 when the product is run on the computer.

15. A computer usable storage device comprising the computer program product of claim 15 stored thereon.

16. An apparatus for determining skin glow and/or skin radiance and/or skin shine and/or the biological age of the skin of a test individual comprising:
(a) A digital camera; and
(b) A digital computer operably linked to the camera such that data gathered by the camera can be downloaded to the computer, the computer comprising the computer program product of claim 14 stored on an internal memory thereof.
